(19) United States
(12) Patent Application Publication
(10) Pub. No.: US 2022/0394958 A1
(43) Pub. Date: Dec. 15, 2022

(54) AQUARIUM FEEDING MACHINE WITH FOOD CARTRIDGE SYSTEM AND METHODS

(71) Applicant: Spectrum Brands, Inc., Middleton, WI (US)

(72) Inventor: Bernd WALLMEIER, Ibbenbüren (DE)

(73) Assignee: Spectrum Brands, Inc., Middleton, WI (US)

(21) Appl. No.: 17/776,790

(22) PCT Filed: Nov. 13, 2020
(86) PCT No.: PCT/US2020/060509

§ 371 Date: May 13, 2022

Related U.S. Application Data
(60) Provisional application No. 62/935,893, filed on Nov. 15, 2019.

(51) Int. Cl. A01K 61/85

(52) U.S. Cl. CPC A01K 61/85

(57) ABSTRACT

A feeding device for feeding aquarium fish includes a housing, a rotatable drum, and a removable and replaceable food cartridge secured to and rotatable with the drum.

### CROSS-REFERENCE TO RELATED APPLICATION

This application is being filed on Nov. 13, 2020, as a PCT International Patent Application and claims the benefit of U.S. Patent Application Ser. No. 62/935,893, filed on Nov. 15, 2019, the disclosure of which is incorporated herein by reference in its entirety.

### TECHNICAL FIELD

This disclosure relates to fish feeders. In particular, this disclosure relates to an automatic feeding machine with a removable and replaceable cartridge of fish food and methods.

### BACKGROUND

Automatic feeding machines for use with aquariums for fish and other aquatic life are known. Such machines are helpful for the fish owners when they cannot be at their aquarium, such as when they are traveling or not home.

In the past, fish feeders had been provided that include refillable containers for the fish food. This exposes the owner to possible mess, due to spilling the fish food, inconvenience, and the possibility of feed stale food to the fish.

What is needed is a system of feeding fish that is convenient, not messy, and which ensures fresh food with proper nutrition for the fish and other aquatic life.

### SUMMARY

An aquarium feeding device for feeding aquarium fish and other aquatic life with a food cartridge is provided that improves the prior art.

In a first aspect, a food cartridge for mounting in an automatic feeding device is provided. The food cartridge includes a casing having a surrounding wall and opposite closed end walls defining an interior volume therein; the casing having a feed aperture in at least one of the surrounding wall or closed end walls; a one-time removable cover-piece removably covering the feed aperture; and a chute secured within the casing having a feed inlet opening in communication with the interior volume and a feed outlet opening at the feed aperture. In one embodiment, the food cartridge further includes a scoop secured within the casing and connected to the chute in proximity to the feed inlet opening.

The food cartridge further includes fish food in the interior volume.

In example embodiments, the chute is secured to one of the end walls of the casing.

In many embodiments, the scoop is secured to one of the end walls of the casing. In many embodiments, the scoop is secured to one of the end walls of the casing.

The feed aperture can be located in the surrounding wall, in example embodiments.

In example embodiments, the feed aperture is against one of the end walls.

In some implementations, the surrounding wall is tubular and the end walls have a flat exterior.

In some embodiments, the surrounding wall is cylindrical, and the end walls have a flat exterior.

In many examples, the casing comprises a disposable plastic.

In some embodiments, the casing comprise biodegradable plastic usable as filter material in an aquarium filter.

In some embodiments, the casing includes means for releasably connecting to a feeding device.

In some examples, the casing includes a color-indicative system of nutrition content of fish food in the interior volume.

In another aspect, a feeding device for feeding aquatic life, such as fish, is provided. The feeding device includes a housing containing a motor; a drum having a longitudinal axis and being rotatable about the axis by the motor; and the food cartridge as variously characterized above removably and replacably secured to the drum and being rotatable with the drum.

In many embodiments, the feeding device further includes a clamp secured to the housing constructed and arranged to permit the housing to be removably clamped to an aquarium.

In many examples, the feeding device further includes a controller in communication with the motor. The controller is programmable to set feeding times and a number of rotations of the drum at each feeding time.

In some example embodiments, the feeding device further includes means for releasably holding the food cartridge.

In another aspect, a method for automatically feeding fish in an aquarium is provided. The method includes providing a housing with a motor and a drum rotatable by the motor; providing a food cartridge containing fish food therein; removing a cover-piece from the cartridge to expose a feed aperture; and mounting the food cartridge to the drum so that the food cartridge rotates with the drum.

The method can further include a step of removing the food cartridge from the drum and disposing or recycling the cartridge, when the food cartridge is spent. The method can include providing a second food cartridge containing fish food therein; removing a cover-piece from the second food cartridge to expose a feed aperture; and mounting the second food cartridge to the drum so that the second food cartridge rotates with the drum.

In some example method, the step of mounting the food cartridge includes fitting together a projection and receiver arrangement on the food cartridge and housing or drum.

In some examples, the food cartridge is provided as variously characterized above.

A variety of examples of desirable product features or methods are set forth in part in the description that follows, and in part will be apparent from the description, or may be learned by practicing various aspects of this disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a schematic view of a feeding device having a removable and a replaceable cartridge of fish food mounted on an aquarium wall, constructed in accordance with principles of this disclosure;

FIG. 2 is another perspective view of the feeding device of FIG. 1 mounted on the aquarium wall;

FIG. 3 is a perspective view of the feeding device of FIGS. 1 and 2;

FIG. 4 is a perspective view of the food cartridge used with the feeding device of FIGS. 1-3;

FIG. 5 is a perspective view of a portion of the interior of the food cartridge of FIGS. 3 and 4;

FIG. 6 is a perspective view of a system for packaging the food cartridge of FIGS. 3 and 4;

FIG. 7 is a perspective view of food cartridges having color codes to be indicative of the nutrition content of the fish food; and

FIG. 8 is a schematic, exploded perspective view showing the feeding device and food cartridge of FIGS. 1 and 2.

### DETAILED DESCRIPTION

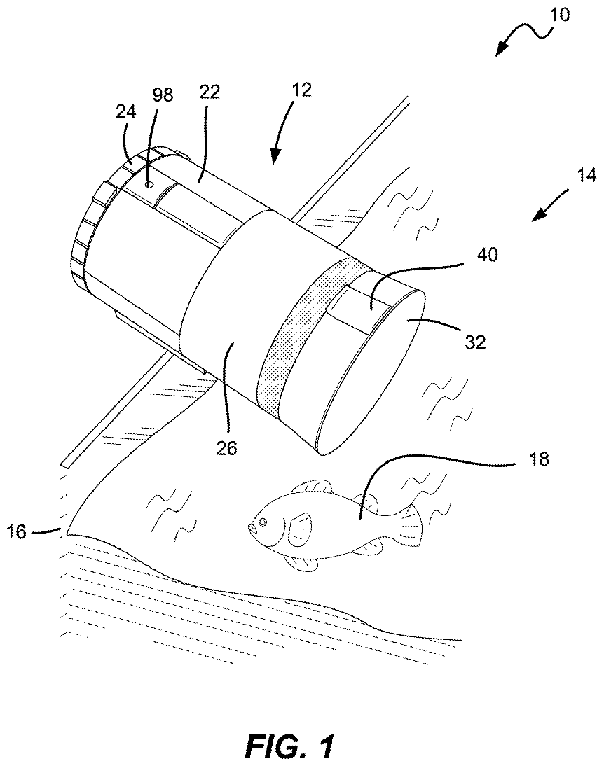

FIG. 1 illustrates schematically a system 10 including a feeding device 12 and an aquarium 14. The aquarium 14 is shown schematically, in which one of the aquarium walls 16 can be seen, along with aquatic life in the form of fish 18.

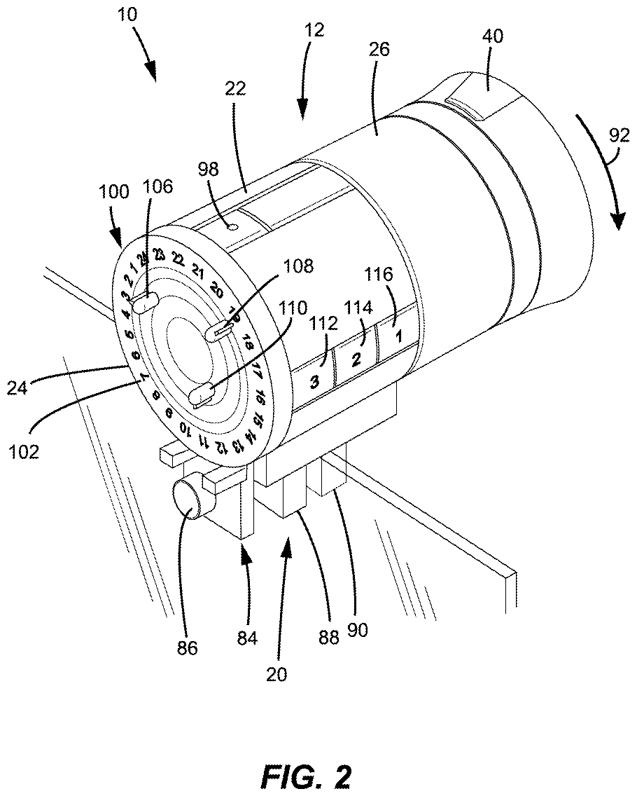

The feeding device 12 is removably mountable on the aquarium wall 16, which is better illustrated in FIG. 2. A clamp arrangement 20 is illustrated in FIG. 2 as removably mounting the feeding device 12 on the aquarium wall 16. Many other embodiments for mounting the feeding device 12 to the aquarium 14 are possible.

In general, the feeding device 12 includes a housing 22 with a rotatable drum 24 and a food cartridge 26. The food cartridge 26 is removably and replaceably secured to the drum 24 and is rotatable with the drum 24.

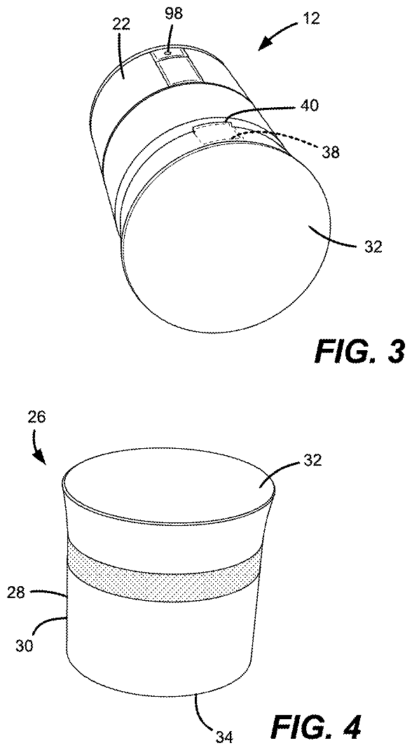

In reference now to FIGS. 3-5, the food cartridge 26 is described in further detail. The food cartridge 26 includes a casing 28. The casing has a surrounding wall 30 and opposite closed end walls 32, 34. An interior volume 36 is defined within the surrounding wall 30 and end walls 32, 34.

In example embodiments, the surrounding wall 30 is tubular, for example, cylindrical. The end walls 32, 34, in the embodiment shown, have a generally flat exterior. In other embodiments. In other embodiments, the surrounding wall 30 and end walls 32, 34 can have alternate shapes.

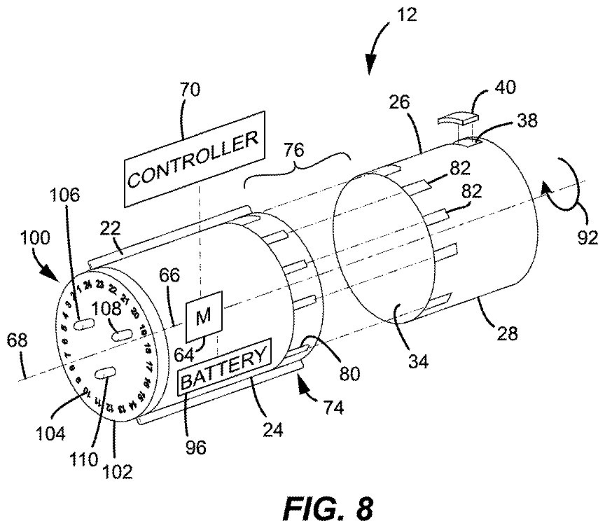

In the casing 28 is a feed aperture 38 (FIG. 8 and in hidden lines in FIG. 3 behind a cover member 40). The feed aperture 38 is generally an opening that allows food to dispense from the interior volume 36 and into the aquarium 14, when the food cartridge 26 is rotated to a position with the feed aperture 38 pointing downward toward the aquarium 14. The feed aperture 38 can be in at least one of the surrounding wall 30 or end walls 32, 34, or a combination thereof.

In the example embodiment shown, the feed aperture 38 is located in the surrounding wall 30. As can be seen in FIG. 3, the feed aperture 38 is in the surrounding wall 30 and against the end wall 32.

The feed aperture 38 is sized to allow the flow of fish food, or whatever the nutrient is, that is stored within the food cartridge 26.

The food cartridge 26 further includes a one-time removable cover-piece 40. The cover piece 40 removably covers the feed aperture 38. The cover piece 40 can be tamper-indicative. When the cover piece 40 is removed, it exposes the feed aperture 38 and allows the flow of food from the interior volume 36 through the feed aperture 38 into the aquarium 14. The cover piece 40 can be a removable tab, or tape, or many different embodiments of tamper indicative features and features that help to seal in the freshness of the food in the cartridge 26.

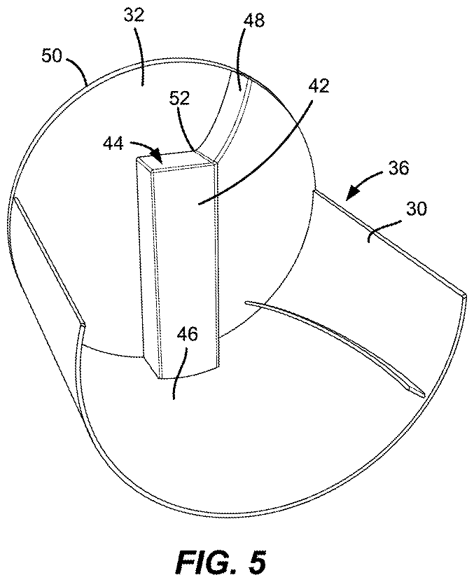

In reference to FIG. 5, the food cartridge 26 includes a chute 42 secured within the casing 28. The chute 42 has a feed inlet opening 44 in communication with the interior volume 36. The feed inlet opening 44 allows for food stored within the interior volume 36 to enter into the chute 42. The chute 42 also includes a feed outlet opening 46 in proximity to or at the feed aperture 38. Thus, food stored within the interior volume 36 can enter the feed inlet opening 44 and be directed through the chute 42 to the feed outlet opening 46 and out of the cartridge 26 through the feed aperture 38.

In the example embodiment shown, the chute 42 is secured to one of the end walls 32, 34. In this embodiment, the chute 42 was secured to the end wall 32.

The food cartridge 26, in the embodiment shown, further includes a scoop 48. The scoop 48 is secured within the casing 28 and is connected to the chute 42 in proximity to the feed inlet opening 44. The scoop 48 helps to direct food in the interior volume 36 into the feed inlet opening 44, as the food cartridge 26 is rotated about it longitudinal axis.

In the example embodiment shown, the scoop 48 is secured to the end wall 32, and extends from an outer perimeter rim 50 to a side end edge 52 of the chute 42. The scoop 48 helps to direct food into the chute 42, while the general volume of the chute 42 helps to allocate the volume of food directed through the feed outlet opening 46 and into the aquarium 14.

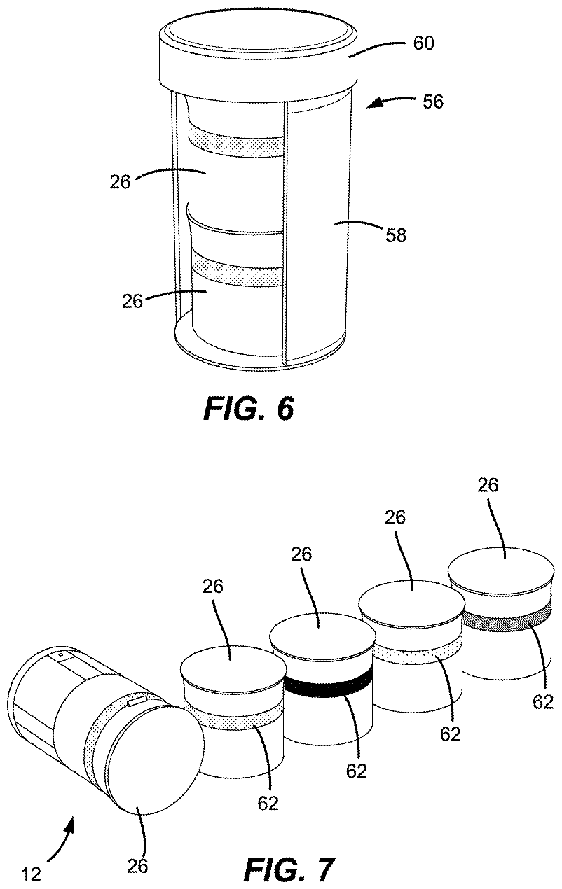

FIG. 6 illustrates an example packaging arrangement 56. In FIG. 6, the packaging arrangement 56 includes a storage canister 58, which holds a plurality of individual food cartridges 26. In this example there are two food cartridges 26 stored within the canister 58. The canister 58 has a removable lid 60 to allow access to the interior of the canister 58, such that when a new food cartridge 26 is needed, the lid 60 can be removed and the interior accessed for the new food cartridge 26.

FIG. 7 illustrates a system for indicating nutrition content of the food cartridges 26. In FIG. 7, each food cartridge 26 has a different color indication 62. The color 62 indicates a specific nutritional content of fish food in the interior volume 36 of the food cartridge 26.

The casing 28 can be made from a variety of materials. In one example, the casing 28 is made from a disposable plastic, such that when the food cartridge 26 is “spent” in that the food is depleted to a point where it needs replacing, the entire cartridge 26 is disposed of and either recycled or incinerated.

In another example, the casing 28 is made from a biodegradable plastic, such that when the food is depleted in the cartridge 26, the casing 28 can be used as filter material for an aquarium filter. The filter material can provide nitrate removal and carbon dioxide fertilization.

In some example embodiments, the casing 28 includes a means for releasably connecting to the feeding device 12. The means for releasably connecting can include, for example, a projection and receiver arrangement 76 (FIG. 8), to ensure that only the proper food cartridge 26 is provided with the feeding device 12. This can be embodied in many forms.

In reference now to FIGS. 1, 2, and 8, the feeding device 12 is shown in further detail. FIG. 8 is a schematic, perspective illustration of the feeding device 12, in which the housing 22 and drum 24 are shown schematically.

Within the housing 22 is a motor 64. The motor 64 rotates a shaft 66. The rotating shaft 66 is connected to the drum 24. The drum 24 has a longitudinal axis 68 and is rotatable about the axis 68 by the motor 64 in the direction shown by arrow 92. When the food cartridge 26 is secured to the drum 24, the food cartridge 26 rotates with the drum 24 about the axis 68 in the direction of arrow 92.

The motor 64 can be energized by one or more batteries 96 (FIG. 8) within the housing 22. An indicator light 98 (FIG. 2) can be held within the housing 22 and visible externally from the housing 22 to show the battery status, e.g. when the light 98 is on, the battery 96 has life (charge).

The feeding device 12 includes a controller 70. The controller 70 may be embodied in the form of a touch pad secured to the housing 22. In other embodiments, the controller 70 can be programmed through Wi-Fi communication with a hand held device. The controller 70 is electronically connected to be in communication with the motor 64. The controller 70 is programmable to set feeding times and a number of rotations of the drum 24 at each feeding time. For example, the controller 70 can be used to set either the times during the day for feeding; or it can be set for feeding during fixed intervals, such as every 8 hours, for example. The controller 70 can also be used to indicate how many rotations of the drum 24 are to take place during each feeding time. Each rotation of the drum 24 will rotate the food cartridge 26, which will dispense one portion of food for each full rotation.

The feeding device 12 includes a manual timer 100 (FIGS. 2 and 8). The manual timer 100 includes a back cover 102 having a series of hour numbers 104 (FIG. 8), in this example, from 1 to 24, corresponding to a 24 hour day. Pins 106, 108, 110 shown projecting axially from the back cover 102 can be used to set the daily feeding schedule by setting the pins next to the corresponding hour number 104. Buttons 112, 114, 116 (FIG. 2) along the side of the housing 22 correspond with the manual timer 100 and drive the number of turns (rotations) of the drum 24 for each feeding. In this example, button 112 corresponds to 3 rotations; button 114 corresponds to 2 rotations; and button 116 corresponds to 1 rotation. Each rotation of the drum 24 will rotate the food cartridge 26, which will dispense one portion of food for each full rotation

The feeding device 12 also includes means for releasably holding the food cartridge and can be the same structure as the means for releasably connecting to the feeding device 12, mentioned above. In FIG. 8, the means for releasably holding is shown at reference numeral 74. The means 74 can be embodied in many different forms including a projection and receiver arrangement 76. In the projection and receiver arrangement 76, the drum 24 has a first member 80 or 82 of the projection and receiver arrangement 76, while the food cartridge 26 has a second member 80 or 82 of the projection and receiver arrangement 76.

In the example shown in FIG. 8, there are a plurality of projections 80 on the drum 24, while there are a plurality of receivers 82 on the food cartridge 26. In some embodiments, there may be both projections 80 and receivers 82 on the drum 24, and both projections 80 and receivers 82 on the food cartridge 26. Many different embodiments are possible.

As mentioned previously, the feeding device 20 can include clamp arrangement 20. The clamp arrangement 20, shown in FIG. 2, can be embodied in many forms and include a clamp 84 including, for example, a threaded bolt 86 and clamp plates 88, 90. The clamp arrangement 20 is constructed and arranged to permit the housing 22 to be removably clamped to the aquarium wall 16. Many alternatives are possible.

The feeding device 12 can be used as part of a method for automatically feeding fish in an aquarium. The method includes providing the housing 22 with motor 64 and drum 24 rotatable by the motor 64. Next, there is a step of providing food cartridge 26 containing fish food therein. Next, the cover piece 40 is removed from the food cartridge 26 to expose the feed aperture 38. Next, the food cartridge 26 is mounted to the drum 24 so that the food cartridge 26 rotates with the drum 24.

When the food cartridge 26 is spent, that is, when it is depleted of a sufficient amount of food, the food cartridge 26 is removed from the drum 24, and the cartridge 26 is either disposed or recycled. A second, new food cartridge 26 is provided. The cover piece 40 is removed from the new food cartridge 26 to expose the feed aperture 38, and then the new food cartridge 26 is mounted to the drum 24 so that the new food cartridge 26 rotates with the drum 24.

The food cartridge 26 can be mounted to the drum 24 by fitting together projection and receiver arrangement 76 to removably mount the cartridge 26 to the drum 24.

The controller 70 is used to indicate either the times of day, or the periods of interval between feedings. When feeding time is triggered, the controller 70 sends a signal to the motor 64, which rotates the drum 24 at least one full rotation 92. The full rotation also rotates the food cartridge 26. This rotation will cause the fish food in the interior volume 36 of the food cartridge 26 to engage against the scoop 48 and fall by gravity into the chute 42. The volume of the chute 42 controls the amount of fish food allotted per one full rotation of the food cartridge. The food then falls by gravity through the feed aperture 38 and into the interior of the aquarium 14. The controller 70 may indicate that the food cartridge 26 should be rotated more than one full rotation, depending on how much food is to be distributed per feeding time.

The feeding device 12 can also operate with a manual control. The user selects which hours of the day for feeding, and pushes one or more of the pins 106, 108, 110 in next to the number 104 that corresponds to the hour of the day. The user also selects how many rotations of the drum 24 by pushing one of the buttons 112, 114, 116. Each rotation of the drum 24 will rotate the food cartridge 26, which will dispense one portion of food for each full rotation.

The above represents example principles. Many embodiments can be made using these principles.

What is claimed is:

1. A food cartridge for mounting in an automatic feeding device; the food cartridge comprising:
(a) a casing having a surrounding wall and opposite closed end walls defining an interior volume therein; the casing having a feed aperture in at least one of the surrounding wall or closed end walls;
(b) a one-time removable cover-piece removably covering the feed aperture; and
(c) a chute secured within the casing having a feed inlet opening in communication with the interior volume and a feed outlet opening at the feed aperture.

2. The food cartridge of claim 1 further comprising a scoop secured within the casing and connected to the chute in proximity to the feed inlet opening.

3. The food cartridge of any one of claims 1 and 2 further comprising fish food in the interior volume.

4. The food cartridge of any one of claims 1-3 wherein the chute is secured to one of the end walls of the casing.

5. The food cartridge of claim 2 and any one of claims 1, 3, and 4, wherein the scoop is secured to one of the end walls of the casing.

6. The food cartridge of any one of claims 1-5 wherein the feed aperture is located in the surrounding wall.

7. The food cartridge of claim 6, wherein the feed aperture is against one of the end walls.

8. The food cartridge of any one of claims 1-7 wherein the surrounding wall is tubular and the end walls have a flat exterior.

9. The food cartridge of any one of claims 1-8 wherein the casing comprises a disposable plastic.

10. The food cartridge of any one of claims 1-8 wherein the casing comprises biodegradable plastic usable as filter material for an aquarium filter.

11. The food cartridge of any one of claims 1-10 wherein the casing includes means for releasably connecting to a feeding device.

12. The food cartridge of any one of claims 1-11 wherein the casing includes a color-indicative of nutrition content of fish food in the interior volume.

13. A feeding device for feeding aquarium fish; the feeding device comprising:
(a) a housing containing a motor;
(b) a drum having a longitudinal axis and being rotatable about the axis by the motor; and
(c) the food cartridge of any one of claims 1-12 removably and replaceably secured to the drum and being rotatable with the drum.

14. The feeding device of claim 13 further comprising a clamp secured to the housing constructed and arranged to permit the housing to be removably clamped to an aquarium.

15. The feeding device of any one of claims 13 and 14 further comprising a controller in communication with the motor; the controller being programmable to set feeding times and a number of rotations of the drum at each feeding time.

16. The feeding device of any one of claims 13-15 further comprising means for releasably holding the food cartridge.

17. A method for automatically feeding fish in an aquarium; the method comprising:
(a) providing a housing with a motor and a drum rotatable by the motor;
(b) providing a food cartridge containing fish food therein;
(c) removing a cover-piece from the cartridge to expose a feed aperture; and
(d) mounting the food cartridge to the drum so that the food cartridge rotates with the drum.

18. The method of claim 17 further comprising:
(a) when the food cartridge is spent, removing the food cartridge from the drum and disposing or recycling the cartridge;
(b) providing a second food cartridge containing fish food therein;
(c) removing a cover-piece from the second food cartridge to expose a feed aperture; and
(d) mounting the second food cartridge to the drum so that the second food cartridge rotates with the drum.

19. The method of claim 17 wherein the step of mounting the food cartridge includes fitting together a projection and receiver arrangement on the food cartridge and housing or drum.

20. The method of any one of claims 17-19 wherein the food cartridge is according to any one of claims 1-12.
